(19) United States
(12) Patent Application Publication
(10) Pub. No.: US 2017/0355535 A1
(43) Pub. Date: Dec. 14, 2017

(54) VACUUM CONVEYOR WITH COGGED DRIVE BELT

(71) Applicant: Brandt Agricultural Products Ltd., Regina (CA)

(72) Inventors: Jonathan Robert Carteri, Regina (CA); Nicholas Broberg, Regina (CA); Michael Ryan Kaeding, Regina (CA); Chance Peutert, Belle Plaine (CA)

(21) Appl. No.: 15/453,158

(22) Filed: Mar. 8, 2017

(30) Foreign Application Priority Data
Jun. 14, 2016 (CA) 2932815

(51) Int. Cl. B65G 53/24; F16H 7/02

(52) U.S. Cl. CPC B65G 53/24; F16H 7/023

(57) ABSTRACT

A vacuum conveyor for conveying granular material is provided. The vacuum conveyor can include a frame, a housing supported by the frame, a fan assembly provided in the housing, the fan section operative to create a vacuum in the housing and a drive mechanism. The drive mechanism can include an input shaft, a toothed input gear operably connected to the input shaft, a toothed output gear operably connected to the fan section and a cogged belt provided around the toothed input gear and the toothed output gear to transfer rotational motion of the toothed input gear to the toothed output gear.

### CROSS-REFERENCE TO RELATED APPLICATION

This application claims priority to and benefit of CA Ser. No. 2,932,815, filed Jun. 14, 2016, the contents of which are incorporated by reference in its entirety for all purposes.

### FIELD OF THE INVENTION

The invention is in the field of pneumatic or vacuum conveyors such as are commonly used to convey grain or other granular material, and in particular to a vacuum conveyor using a cogged drive belt to transfer rotation motion from a vehicle to a fan assembly.

### BACKGROUND

Vacuum conveyors for conveying granular material, such as grain, using a vacuum are well known. These vacuum conveyors allow pickup of the granular material with a flexible hose that allows considerable freedom of movement. A fan or air pump is used to establish a flow of air from the intake end of the hose through the machine to a discharge. An intake nozzle at the end of the housing of the vacuum conveyor is placed in the granular material and the air being sucked into the intake end picks up and carries the granular material into the intake nozzle. The intake nozzle establishes a stream of mixed air and granular material causing the granular material sucked up into the intake nozzle to be carried through the hose back to the housing of the vacuum conveyor. Typically, the hose is attached to a rigid tube, with the tube and hose forming an intake conduit between the intake nozzle and the housing of the vacuum conveyor. Each of these machines typically has a way to discharge the granular material that has been sucked into the machine through the intake conduit, such as with a discharge conveyor (commonly an auger). When the granular material reaches the housing of the vacuum conveyor, the vacuum conveyor deposits the granular material in the discharge conveyor which can then carry the granular material up the length of the discharge conveyor to be discharged into a bin, trailer, truck, etc.

Sections of tubing/hose can be added or removed depending on the distance between the vacuum conveyor and the granular material to be collected.

Since these vacuum conveyors are usually powered off the PTO of a tractor, the less loss of rotational motion from the PTO of the tractor to the fan or air pump, the better the vacuum conveyor will perform.

### BRIEF SUMMARY

In an aspect, a vacuum conveyor for conveying granular material is provided. The vacuum conveyor can include a frame, a housing supported by the frame, a fan assembly provided in the housing, the fan section operative to create a vacuum in the housing and a drive mechanism. The drive mechanism can include an input shaft, a toothed input gear operably connected to the input shaft, a toothed output gear operably connected to the fan section and a cogged belt provided around the toothed input gear and the toothed output gear to transfer rotational motion of the toothed input gear to the toothed output gear.

### DESCRIPTION OF THE DRAWINGS

A preferred embodiment of the present invention is described below with reference to the accompanying drawings, in which:

FIG. 1 is a perspective view of a vacuum conveyor;

FIG. 2 is a perspective view of the vacuum conveyor of FIG. 1 in a transport position;

FIG. 3 is a perspective view of the vacuum conveyor in an operating position showing the hose section and intake nozzle attached;

FIG. 4 illustrates a perspective view of the vacuum conveyor of FIG. 1 showing the components of a drive mechanism;

FIG. 5 is a perspective view the components of the drive mechanism;

FIG. 6 is a perspective view of a cogged belt that makes up a component in the drive mechanism; and

FIG. 7 is a perspective view of a toothed output pulley.

### DETAILED DESCRIPTION OF THE ILLUSTRATED EMBODIMENTS

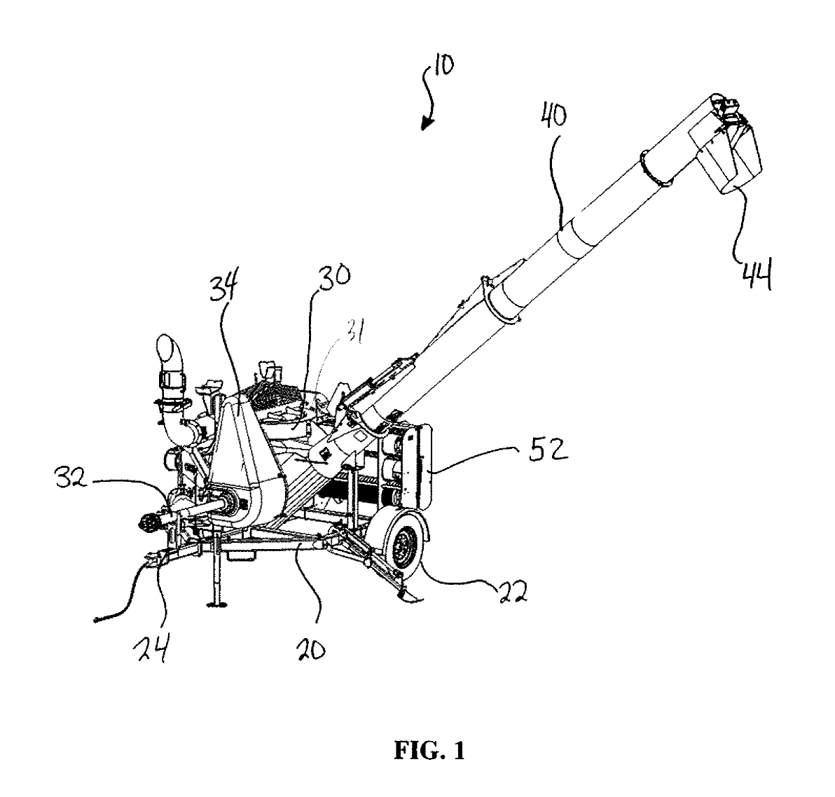

FIG. 1 illustrates a perspective view of a vacuum conveyor 10 for conveying granular material such as grain or other crop material. The vacuum conveyor 10 includes a frame 20 with ground wheel 22 to transport the vacuum conveyor 10 and a hitch assembly 24 to allow the vacuum conveyor 10 to be connected to a tow vehicle (not shown) for transport to a location. The vacuum conveyor 10 can have a housing 31 that contains a fan assembly 30 that creates a vacuum that is used to create a flow of air in a hose section 50 and an intake nozzle 100 to carry granular material up into the intake nozzle 100 and through the hose section 50 into the vacuum conveyor 10.

Inside the vacuum conveyor 10, the air flow carrying the granular material is directed into an inlet of a discharge conveyor section 40 so that the granular material being carried in the air flow drops into the intake of the discharge conveyor section 40 provided inside the vacuum conveyor 10, where the granular material can be carried up the discharge conveyor section 40 to be discharged from a discharge spout 44 on the end of the discharge conveyor section 40. The discharge conveyor section 40 can have a conveyor belt, auger, etc.

There are a number of ways to get the granular material to drop out of the air flow and into the inlet of the discharge conveyor section 40, including a rapid change in direction of the air flow, the provision of a nozzle to change the velocity of the air flow, etc.

The fan assembly 30 used to create the vacuum in the vacuum conveyor 10 can be driven off of a PTO of the tow vehicle. In one aspect, a PTO shaft 32 can be connected to the fan assembly 30 by a drive mechanism 34 that transfers the rotational motion of the PTO shaft 32 to the fan assembly 30 to turn a fan. The PTO shaft 32 can be connected to the PTO of the tow vehicle.

Alternatively, the vacuum conveyor 10 can include a motor provided on the frame 20 to drive the fan assembly 3 and an output shaft of the motor can be connected to the drive mechanism 34.

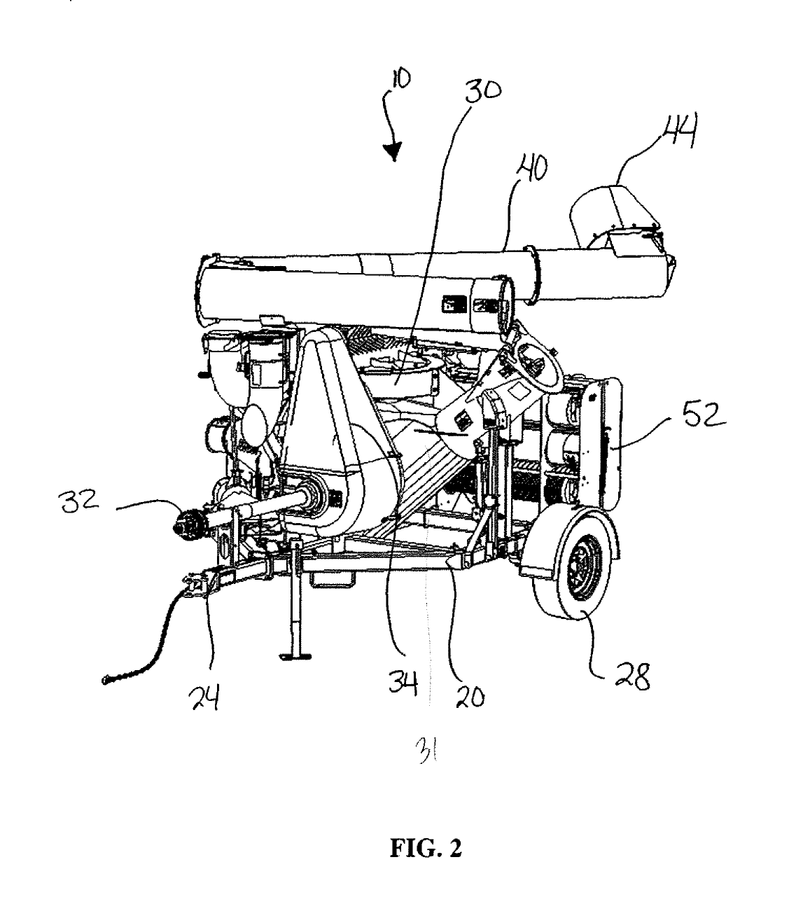

To transport the vacuum conveyor 10, the vacuum conveyor 10 can be placed in a transport position as shown in FIG. 2. The conveyor section 40 can be folded up to allow easier transport and the hose section 50 and the intake nozzle 100 removed and stored in a hose storage rack 52. A tow vehicle (not shown) can be hitched to the hitch assembly 24 and the vacuum conveyor 10 towed using its ground wheels 22 by the tow vehicle.

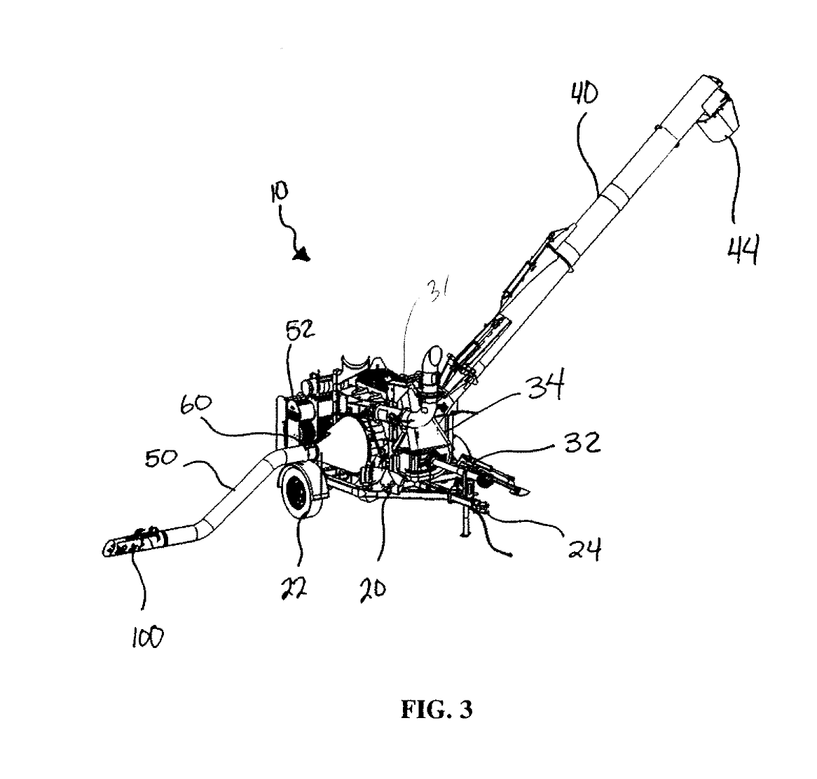

Referring to FIG. 3, once in position to collect and convey granular material, the vacuum conveyor 10 can be positioned beside a grain bin or other place where the granular material to be conveyed is located. The conveyor section 40 can then be unfolded so that the discharge spout 44 can be directed to discharge the granular material where desired. The hose section 50 and the intake nozzle 10 can be removed from the hose storage rack 52 and a proximal end of the hose section 50 can be attached to an intake tube 60 on the vacuum conveyor 10 while the distal end of the hose section 50 can be connected to the intake nozzle 100.

To use the vacuum conveyor 10, an operator can place the end of the intake nozzle 100 into a pile of granular material to be conveyed by the vacuum conveyor 10 while the fan assembly 30 is being used to create a vacuum in the vacuum conveyor 10 and thereby creating an air flow being sucked into the hose section 50. The granular material will be sucked into the intake nozzle 100 by this air flow entering the hose section 50 and the granular material will be carried up the hose section 50 mixed in with this air flow and into the inlet of the conveyor section 40 provided inside the vacuum conveyor 10. Once in the inlet of the conveyor section 40 the granular material will pass up the conveyor section 40 to be discharged out the discharge spout 44.

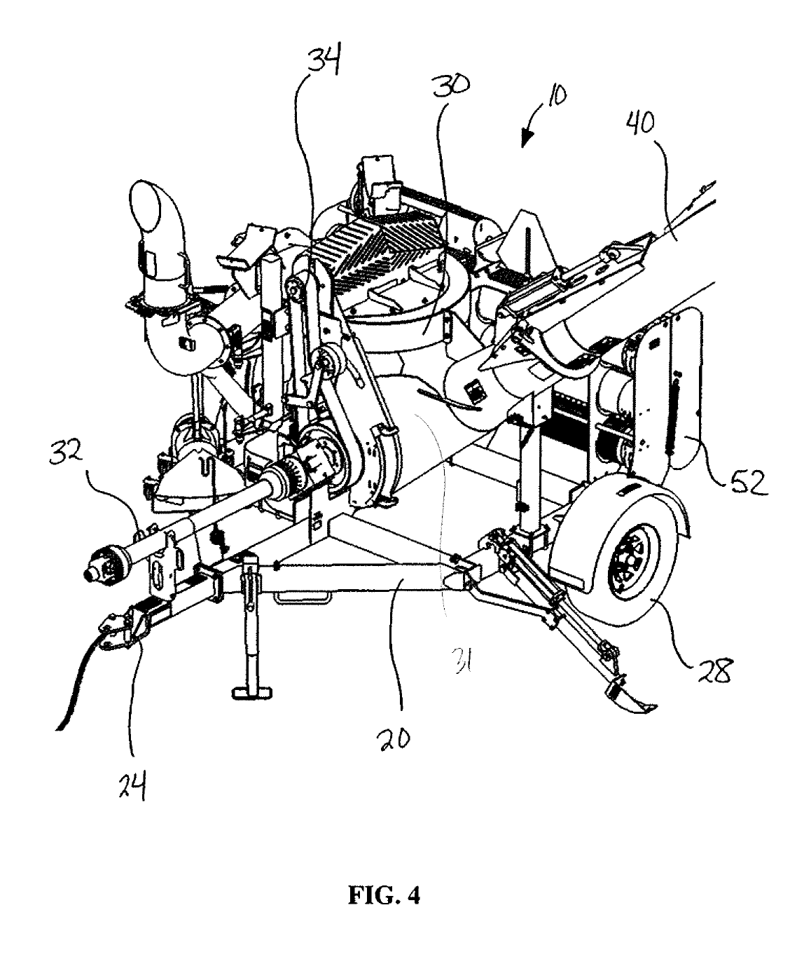

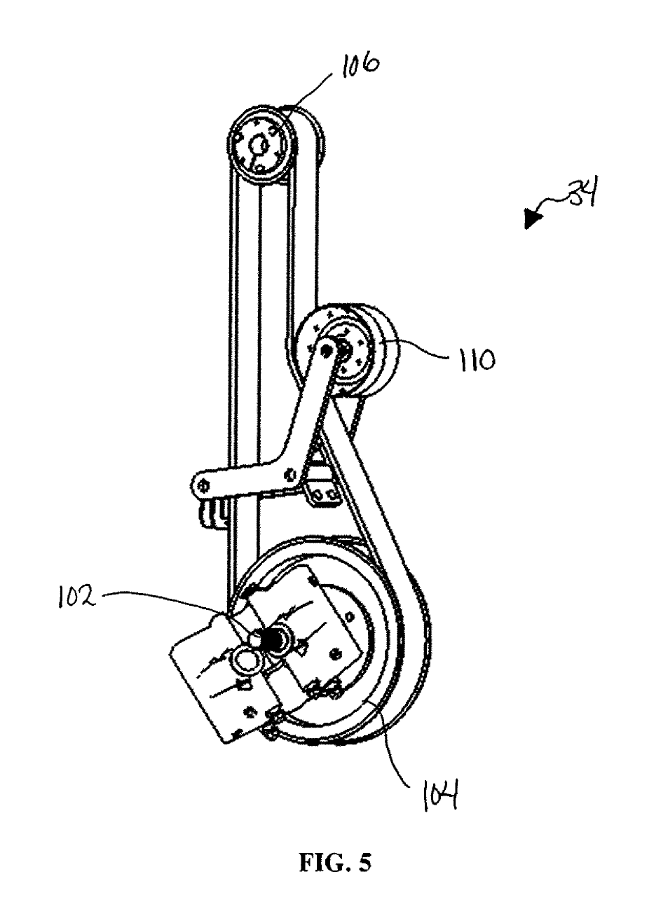

FIG. 4 illustrates the vacuum conveyor 10 with a cover removed from the drive mechanism 34 to show the components making up the drive mechanism 34 and FIG. 5 illustrates the components of the drive mechanism 34. The drive mechanism 34 is made up of a belt and pulley system that is used to transmit rotational motion from the PTO of the tow vehicle to the fan assembly 30. The drive mechanism 34 can include an input shaft 102 that is connected to the PTO shaft 32 (not shown in FIG. 5).

A toothed input pulley 104 can be provided attached to the input shaft 102 so that rotation of the input shaft 102 will rotate the toothed input pulley 104. The toothed input pulley 104 can have a series of regularly spaced teeth on the pulley surface.

A toothed output pulley 106 is provided to transfer rotational motion of the toothed output pulley 106 to the fan assembly 30. The toothed out pulley 106 can have a series of regularly spaced teeth 107 on the pulley surface.

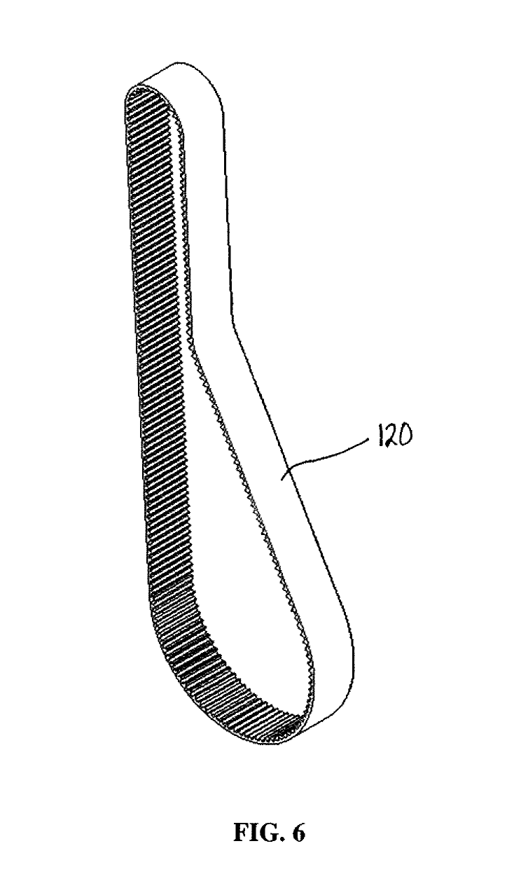

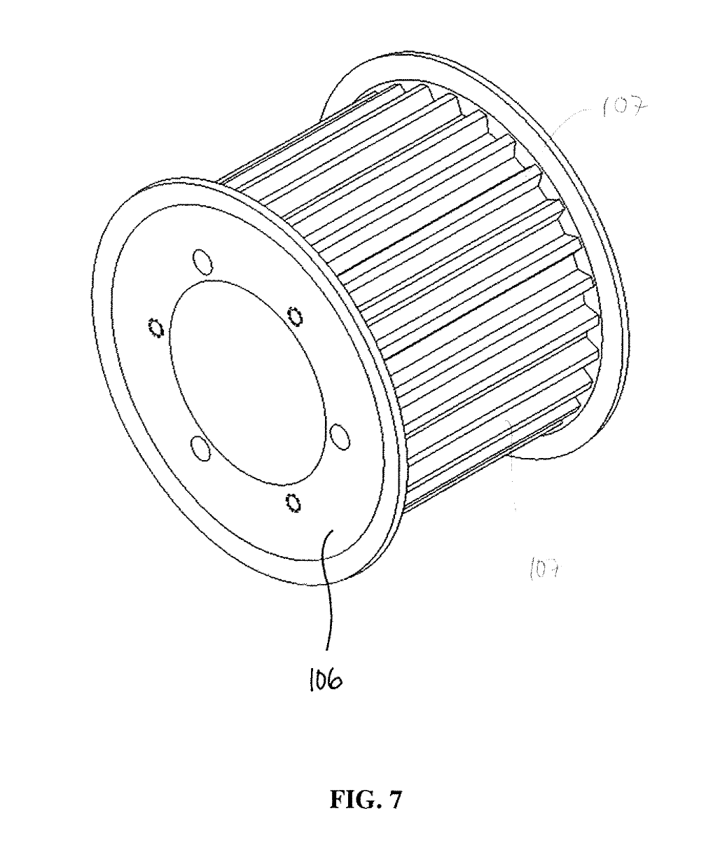

A cogged belt 120 can be provided to transfer rotational motion from the toothed input pulley 104 to the toothed output pulley 106. The cogged belt 120 can be provided with a series of regular spaced teeth (shown in FIG. 6) that mesh with teeth on the toothed input pulley 104 and teeth on the toothed output pulley 106 (shown in FIG. 7).

A tensioner pulley assembly 110 can be provided to apply a tension on the cogged belt 120 to keep it in sufficient contact with the toothed input pulley 104 and toothed output pulley 106.

By using the cogged belt 120 with teeth sized and spaced to mesh with the teeth on the toothed input pulley 104 and the teeth on the toothed output pulley 106, the output from the PTO on the tow vehicle will be positively connected to the fan assembly 30 so that all of the rotational force of the PTO shaft 32 is transferred through the drive mechanism 34 to the fan assembly 30. Unlike a v-belt, flat belt or other type of belt that can slip, the cogged belt 120 prevents any belt slippage from occurring and therefore any loss of rotational force of the PTO shaft 32 through the drive mechanism 34.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A vacuum conveyor for conveying granular material, the vacuum conveyor comprising:
a frame;
a housing supported by the frame a fan assembly provided in the housing, the fan section operative to create a vacuum in the housing;
a drive mechanism comprising:
an input shaft;
a toothed input gear operably connected to the input shaft;
a toothed output gear operably connected to the fan section; and
a cogged belt provided around the toothed input gear and the toothed output gear to transfer rotational motion of the toothed input gear to the toothed output gear.

2. The vacuum conveyor of claim 1 wherein the cogged belt has a series of regularly spaced teeth and wherein the spacings of the teeth on the cogged belt corresponds with spacings of teeth on the toothed input pulley and spacings of teeth on the toothed output pulley.

3. The vacuum conveyor of claim 2 wherein the teeth on the cogged belt mesh with the teeth on the toothed input pulley and the teeth on the toothed output pulley.

4. The vacuum conveyor of claim 1 wherein the drive mechanism further comprises a tensioner pulley assembly positioned to apply tension to the cogged belt.

5. The vacuum conveyor of claim 1 further comprising at least one group wheel operably connected to the frame.

6. The vacuum conveyor of claim 5 further comprising a hitch assembly connected to the frame.

7. The vacuum conveyor of claim 1 wherein the vacuum section has an intake tube connectable to a distal end of a hose section.

8. The vacuum conveyor of claim 8 wherein the vacuum section is connected to a discharge conveyor section and wherein granular material that travels through the hose section into the vacuum conveyor is directed into the discharge conveyor section.

9. The vacuum conveyor of claim 9 wherein the conveyor section comprises an auger and has a discharge spout.

10. The vacuum conveyor of claim 7 wherein the hose section has a proximal end connected to an intake nozzle.

11. The vacuum conveyor of claim 1 wherein the input shaft is connected to a PTO shaft.
